(19) United States
(12) Patent Application Publication
(10) Pub. No.: US 2026/0140876 A1
(43) Pub. Date: May 21, 2026

(54) MEMORY CONTROLLER, INFORMATION PROCESSING DEVICE, AND METHOD FOR PROCESSING ACCESS TO SECONDARY STORAGE DEVICE

(71) Applicant: Sony Interactive Entertainment Inc., Tokyo (JP)

(72) Inventors: Hiroshi Kyusojin, Tokyo (JP); Hideyuki Saito, Chiba (JP)

(21) Appl. No.: 19/449,096

(22) Filed: Jan. 14, 2026

Related U.S. Application Data
(63) Continuation of application No. PCT/JP2024/024541, filed on Jul. 8, 2024.

(30) Foreign Application Priority Data
Jul. 26, 2023 (JP) 2023-121458

(51) Int. Cl. G06F 12/06; G06F 12/0873

(52) U.S. Cl. CPC G06F 12/06; G06F 12/0873; G06F 2212/7201

(57) ABSTRACT

When an information processing device 10 is in a standby state, a sub-CPU 38 stores data downloaded from a server 50 in a flash memory 30 using a logical address that is common to a main CPU 20. In boot process of the information processing device 10, the main CPU 20 reads the data stored in the flash memory 30 by the sub-CPU 38, and displays the data on a display device before the boot process is completed.

### CROSS-REFERENCE TO RELATED APPLICATIONS

This application is a Bypass-Continuation application of and claims the benefit of priority to PCT Application No. PCT/JP2024/024541, filed on Jul. 8, 2024, which claims priority to Japanese Application No. 2023-121458, filed on Jul. 26, 2023, the contents of which are hereby incorporated by reference.

### TECHNICAL FIELD

The present invention relates to a memory controller and an information processing device for accessing a secondary storage device, and a method for processing access to the secondary storage device.

### BACKGROUND TECHNOLOGY

Information processing devices such as personal computers and game devices are constantly connected to networks, so that it is possible to transmit and receive necessary information to and from servers at any time. For example, Cited Literature 1 discloses a technology in which a sub-CPU operates even in a standby state where main power is turned off, thereby transmitting information in response to requests from a server and downloading necessary data from the server.

### CITATION LIST

### Patent Documents

[Patent Document 1] Japanese Unexamined Patent Publication No. 2013-257717

### SUMMARY OF INVENTION

### Problem to be Solved by Invention

Generally, the information processing device activates a basic input output system (BIOS) or an operating system (OS) when a user turns on the main power, and is available for use after initializing various devices, activating system services, performing network authentication, and the like. Meanwhile, the information processing device is dedicated to the boot process, so that even if new data is downloaded in the standby state, it takes time to start the process using the data. In addition, a waiting time to complete the boot process may be stressful for the user.

The present invention has been made in view of the above-described problems, and an object of the present invention is to provide a technology for improving efficiency of a process at the time of or after activating an information processing device. In addition, another object of the present invention is to reduce a stress on a user caused by a waiting time when the information processing device is activated.

### Means to Solve the Problem

One aspect of the present invention relates to a memory controller. The memory controller that acquires an access request to a secondary storage device from a main CPU and a sub-CPU provided in an information processing device to execute a corresponding access process, in which the memory controller generates a logical address space for the sub-CPU, maps the logical address space for the sub-CPU to a logical address space for the main CPU, and executes the access process to the secondary storage device based on the logical address specified in each logical address space in response to the access request.

Another aspect of the present invention relates to an information processing device. The information processing device includes: the memory controller; the main CPU; and the sub-CPU, in which the main CPU causes an image, which is stored in the secondary storage device by the sub-CPU when the main CPU is in a standby state, to be displayed on a display device as a boot image during the boot process of the information processing device.

Still another aspect of the present invention is a method for processing access to a secondary storage device. The method for processing access to the secondary storage device includes: generating a logical address space for a sub-CPU, in which the logical address space is a space of logical addresses for allowing a main CPU and the sub-CPU to implement the access to the secondary storage device, and mapping the logical address space for the sub-CPU to a logical address space for the main CPU; acquiring, from the main CPU and the sub-CPU, an access request to a common storage area, which specifies a logical address in each logical address space; and executing the access process to the secondary storage device based on the specified logical address in response to the access request.

Any combination of the above components and conversion of expressions of the present invention into a method, a device, a system, a computer program, a recording medium having a computer program recorded therein, and the like, are also valid as aspects of the present invention.

### Effect of the Invention

According to the present invention, it is possible to improve efficiency of a process at the time of or after activating the information processing device. In addition, it is possible to reduce the stress on the user caused by the waiting time when the information processing device is activated.

### BRIEF DESCRIPTION OF THE DRAWINGS

FIG. 1 is a diagram illustrating an internal configuration of an information processing device according to the present embodiment.

FIG. 2 is a diagram schematically illustrating a relationship between a created logical address space and a storage area in a flash memory according to the present embodiment.

FIG. 3 is a flowchart illustrating a procedure of a boot process of a general information processing device.

FIG. 4 is a flowchart illustrating a procedure example of a process performed by the information processing device of the present embodiment in a standby state.

FIG. 5 is a flowchart illustrating a procedure example of the boot process of the information processing device according to the present embodiment.

FIG. 6 is a flowchart illustrating a procedure example of a process of displaying a boot image by a main CPU in S68 of FIG. 5.

### DESCRIPTION OF THE EMBODIMENTS

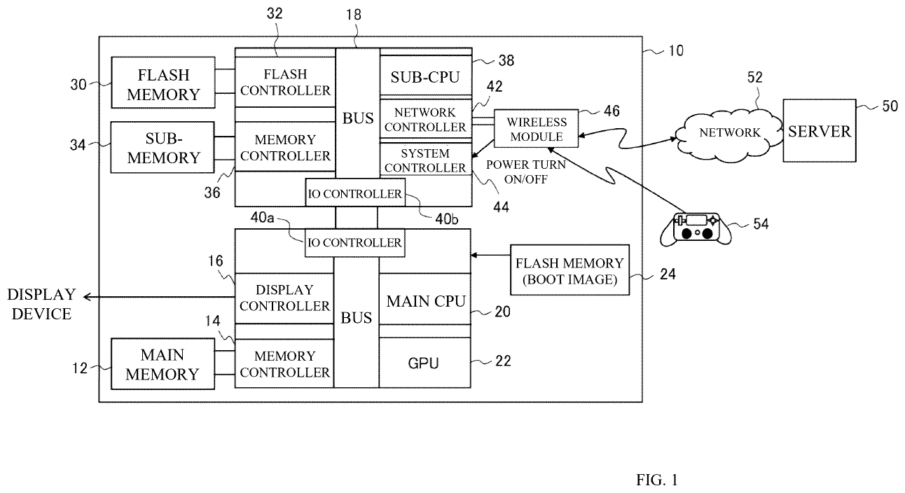

FIG. 1 illustrates an internal configuration of an information processing device according to the present embodiment. The information processing device illustrated herein may be any of general information devices such as a portable game console, a personal computer, a mobile phone, a tablet terminal, or a PDA. Although FIG. 1 illustrates the configuration required for the present embodiment, the configuration of the information processing device is not limited thereto.

An information processing device 10 has a main central processing unit (CPU) 20 that operates in a state where main power is turned on, and a sub-CPU 38 that operates in a state where the main power is turned off. When a user turns on the main power, the main CPU 20 is activated and the sub-CPU 38 is in a standby state. When the main power is turned off, the sub-CPU 38 is activated and the main CPU 20 is in the standby state. Hereinafter, switching the main power from turn-off to turn-on may be referred to as “activation of the information processing device”, the state where the main power is turned on may be referred to as an “activated state of the information processing device”, and the state where the main power is turned off may be referred to as a “standby state of the information processing device”.

In addition to the main CPU 20 and the sub-CPU 38, the information processing device 10 includes a NAND flash memory 30 (hereinafter simply referred to as a flash memory 30), a flash controller 32, a main memory 12, a memory controller 14 for the main memory 12, a display controller 16, a GPU 22, a flash memory 24 for a boot image, IO controllers 40a and 40b, a sub-memory 34, a memory controller 36 for the sub-memory 34, a network controller 42, a system controller 44, and a wireless module 46. These units transmit and receive signals to and from each other via a bus 18.

When the information processing device 10 is in the standby state, power supply to large scale integration (LSI) including the main CPU 20, the memory controller 14 for the main memory 12, the display controller 16, the GPU 22, and the IO controller 40a is cut off, so that the information processing device 10 is in a power saving mode. When the information processing device 10 is activated, power is supplied to the LSI. Then, the main CPU 20 loads a program or data stored in the flash memory 30 into the main memory 12 and uses the program or data to perform an information process. The main CPU 20 downloads data from a server 50 via a network 52 as needed to store the data in the flash memory 30.

The flash memory 30 is a secondary storage device composed of a NAND flash memory, and stores various programs or data. The data may include data read from a recording medium that is driven by a recording medium drive unit (not illustrated), or data downloaded from the server 50. The flash controller 32 acquires an access request to the flash memory 30 from the main CPU 20 or the sub-CPU 38, and writes or reads the data in response to the access request.

For example, the main CPU 20 generates an access request specifying a logical address (LBA: logical block address) of an access destination in the flash memory 30 to store the access request in the main memory 12. The flash controller 32 reads the access request stored in the main memory 12 and converts the specified logical address into a physical address of the flash memory 30. Therefore, the flash controller 32 stores, in an internal memory, at least a part of an address conversion table for converting the logical address into a physical address. The flash controller 32 accesses a corresponding area of the flash memory 30 based on the physical address acquired by the address conversion table to read or write data requested by the main CPU 20.

In addition, the flash controller 32 creates a logical address space for the sub-CPU 38 in response to the request from the main CPU 20. Thus, the sub-CPU 38 can share a predetermined area in the flash memory 30 with the main CPU 20 without using a file system of the main CPU 20. Details thereof will be described later. The flash controller 32 may be a device independent of the information processing device 10 together with the flash memory 30.

The main memory 12 is a primary storage device such as random access memory (RAM), into which the data for various processes is deployed by the main CPU 20. The memory controller 14 acquires an access request to the main memory 12 from the main CPU 20 so as to execute an access process in response to the access request. The GPU 22 draws a display image under the control of the main CPU 20 and stores the data in a frame buffer provided in the main memory 12.

The display controller 16 reads display image data from the frame buffer and outputs the image display data to a display device in sequence at appropriate timing, thereby displaying a still image or moving image. The IO controllers 40a and 40b control I/O devices or interfaces thereof. The flash memory 24 for a boot image is an external flash memory that stores a boot loader and a BIOS image required for booting the information processing device 10.

The wireless module 46 performs wireless communication with an input device 54, such as a game controller or a Wi-Fi router (not illustrated), using a communication protocol such as a Bluetooth (registered trademark) protocol or an IEEE802.11 protocol. As a result, the information processing device 10 establishes communication with the server 50 via the network 52 such as the Internet. However, the connection between the information processing device 10 and the input device 54 or the network 52 is not limited to wireless communication. The network controller 42 controls communication with the input device 54 or the server 50 in response to a request from the main CPU 20 or the sub-CPU 38.

The system controller 44 controls basic operations of a system, such as power management, interrupt requests, and system clock. For example, the system controller 44 detects a turn-on operation and a turn-off operation of the main power by the user. In the illustrated example, a means for the turn-on operation and the turn-off operation is assigned to the input device 54, and the system controller 44 acquires operation details via the wireless module 46. However, a route of operation information is not limited thereto, and the system controller 44 may detect, for example, an operation on a power button (not illustrated).

When the turn-on operation of the main power is detected, the system controller 44 allows the sub-CPU 38 in operation to transition to the standby state and activate the main CPU 20. When the turn-off operation of the main power is detected, the system controller 44 allows the main CPU 20 in operation to transition to the standby state and activate the sub-CPU 38.

In this case, the system controller 44 cuts off the power supply to the LSI including the main CPU 20 as described above. Basically, the flash controller 32 is also in the standby state. Immediately before, the main CPU 20 saves the data in the main memory 12 into the flash memory 30. As a result, at the next activation, the saved data can be read into the main memory 12 and the process can be restarted. In addition, the main CPU 20 stores session information with the server 50 in the flash memory 30.

When the information processing device 10 is in the standby state, the sub-CPU 38 loads the program or data stored in the flash memory 30 into the sub-memory 34, and uses the program or data to perform the information process. The sub-memory 34 is a primary storage device such as random access memory (RAM), into which the data for various processes is deployed by the sub-CPU 38. The memory controller 36 acquires an access request to the sub-memory 34 from the sub-CPU 38 so as to execute the access process in response to the access request. The sub-CPU 38 reads the session information stored in the flash memory 30 by the main CPU 20 into the sub-memory 34 and takes over the connection, thereby periodically accessing the server 50.

As a result of the sub-CPU 38 accessing the server 50, the presence of data that is to be presented to the user may be detected. For example, the data corresponds to update information for previously purchased application programs, messages from other users who are registered as friends, data on still images or moving image shared with other users, new information or campaign information from companies, and the like. In recent years, such information is transmitted regardless of time or place, and the amount of the information transmitted continues to increase.

The information processing device 10 downloads the data at any time even in the standby state, thereby improving the efficiency of the process in the activated state. Hereafter, such information that is created and provided over time will be referred to as “dynamic content”, and information such as pre-created and unchanging images will be referred to as “static content”. When the presence of the dynamic content is detected in the server 50, the sub-CPU 38 downloads the data to store the data in the flash memory 30. In this case, the sub-CPU 38 releases the standby state of the flash controller 32, and then requests writing to the flash memory 30.

The data is basically processed by the main CPU 20 when the information processing device 10 is activated or in the activated state. On the other hand, the main CPU 20 manages the data stored in the flash memory 30 using its own file system. Therefore, in order for the sub-CPU 38 to be able to share a storage area with the main CPU 20, a complicated procedure is required. If easy sharing is allowed, security issues such as data tampering through impersonation may arise.

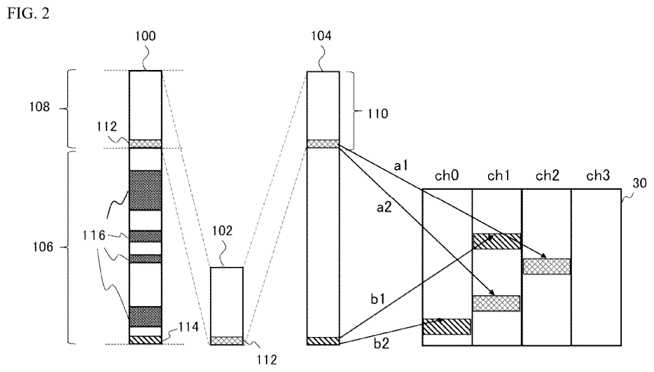

Thus, the flash controller 32 of the present embodiment creates the logical address space for the sub-CPU 38, thereby enabling the sub-CPU 38 to access the same storage area as the main CPU 20 in a unique format. FIG. 2 is a diagram schematically illustrating a relationship between the created logical address space and a storage area in the flash memory 30 according to the present invention. From the left end of FIG. 2, a logical address space 100 for the main CPU 20, a logical address space 102 for the sub-CPU 38, an address conversion table 104, and the storage area in the flash memory 30 are illustrated.

As described above, the flash controller 32 converts the logical address specified by the main CPU 20 into a physical address based on the address conversion table 104. In the present embodiment, a frame of the logical address that can be specified by the sub-CPU 38 is set, and the logical address within the range can also be converted into a physical address. The frame of the logical address corresponds to the logical address space 102 for the sub-CPU 38. The address conversion table 104 includes a data area 110 for converting the logical address for the sub-CPU 38 into a physical address.

Accordingly, the sub-CPU 38 can implement access to the flash memory 30 using a logical address within the range of the logical address space 102. For example, the sub-CPU 38 issues a data write request by specifying a logical address 112 in the logical address space 102, and stores the data write request together with data to be written in the sub-memory 34. The flash controller 32 reads the data write request and the data to be written, converts the logical address into a physical address by referring to the address conversion table 104, and writes the data into a corresponding area in the flash memory 30 (arrows a1 and a2).

FIG. 2 illustrates that the flash memory 30 has four channels “ch0” to “ch3” and the data is stored in a distributed manner. However, the number of channels in the flash memory 30 is not limited. Similarly, the main CPU 20 also implements access to the flash memory 30 using the logical address within the range of the logical address space 100 for the main CPU 20.

For example, the main CPU 20 issues a data write request by specifying a logical address 114 in the logical address space 100, and stores the data write request together with data to be written in the main memory 12. The flash controller 32 reads the data write request and the data to be written, converts the logical address into a physical address by referring to the address conversion table 104, and writes the data into a corresponding area in the flash memory 30 (arrows b1 and b2).

In this case, the logical address space 100 for the main CPU 20 includes an area 106 of a logical address that can only be used by the main CPU 20, and an area 108 of a logical address that can be used by the sub-CPU 38. The area 108 of the logical address is an area to which the logical address space 102 for the sub-CPU 38 is mapped. Accordingly, the main CPU 20 can implement access to the flash memory 30 by specifying a logical address (for example, the logical address 112) that can be specified by the sub-CPU 112.

For example, the main CPU 20 writes information to be taken over to the sub-CPU 38, such as session information with the server 50, into the flash memory 30 using the logical address in the area 108. Therefore, the sub-CPU 38 can read the information using the same logical address. In addition, the sub-CPU 38 writes, for example, the data downloaded from the server 50 into the flash memory 30 using the logical address in its own logical address space 102. Therefore, the main CPU 20 can read the data using the same logical address.

In this way, the sub-CPU 38 can access the flash memory 30 using a unique format without constructing a file system for a given logical address space. For example, the sub-CPU 38 can sequentially store the data downloaded from the server 50 in consecutive logical addresses. On the other hand, after the main CPU 20 reconstructs the file system through the boot process of the information processing device 10, the sub-CPU 38 can access the data stored in the flash memory 30.

When the information processing device 10 is activated, the main CPU 20 requests the flash controller 32 to create the logical address space 102 for the sub-CPU 38. In this case, the flash controller 32 invalidates the original logical address in the logical address area 106, which can only be used by the main CPU 20, by the amount of frames of the logical address to be given to the sub-CPU 38. That is, a part of an area 116 of the logical address is invalidated such that the storage capacity indicated by the logical address does not change before and after the addition of the area 108 of the logical address that can be used by the sub-CPU 38.

This prevents the use of the logical address exceeding the capacity of the flash memory 30. The invalidation of the logical address may be implemented by actually writing dummy data into an area of a target logical address to use the area as a reserved area. According to the configuration of the address space illustrated in FIG. 2, it is possible to easily and safely implement transfer of the data between the main CPU 20 and the sub-CPU 38. Furthermore, the area 108 of the logical address that can be used by the sub-CPU 38 does not need to go through the file system, and can be accessed directly without waiting for a system module to be activated. Therefore, in the standby state, the data stored in the flash memory 30 can be read and processed at an early stage during the boot process of the information processing device 10.

For example, the main CPU 20 can display still images or moving images showing the dynamic content that has been downloaded in the standby state or generated by the sub-CPU 38 in parallel with the boot process of the information processing device 10. Hereinafter, the aspect will be described below. First, in order to clarify the effect of the present embodiment, the boot process of a general information processing device will be briefly described.

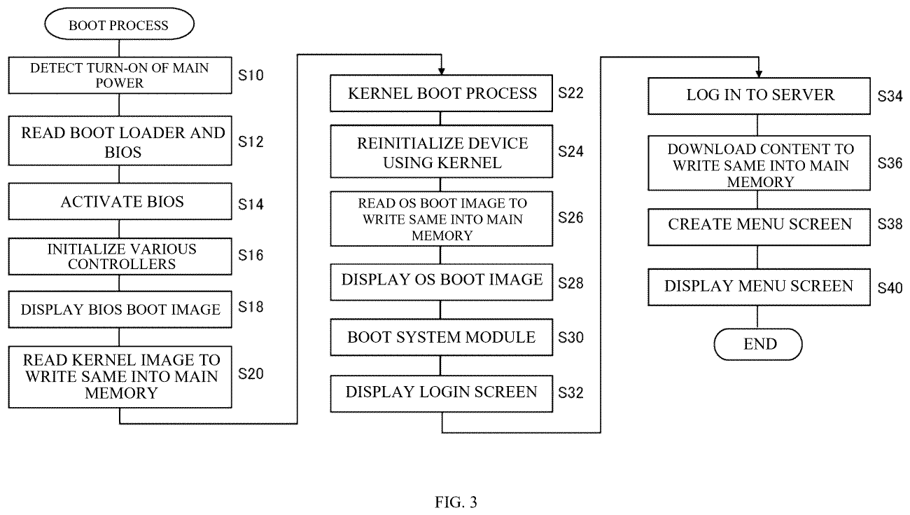

FIG. 3 is a flowchart illustrating a procedure of the boot process of the general information processing device. First, when the user turns on the main power, the system controller 44 detects the turn-on of the main power, and power is supplied to the LSI including the main CPU 20 (S10). Then, the main CPU 20 reads the boot loader and the BIOS image from the external flash memory 24 (S12), and activates the BIOS (S14).

When the BIOS is activated, the main CPU 20 initializes the IO controllers 40a and 40b, the display controller 16, the memory controller 14, and the flash controller 32 (S16), and then displays a BIOS booting image on the display device via the display controller 16 (S18). In this state, the main CPU 22 reads a kernel image, which is part of an OS, from the flash memory 30, deploys the kernel image into the main memory 12 (S20), and then activates the kernel, thereby shifting control to the OS (S22).

In this case, the main CPU 20 reinitializes the device using the kernel to restore an operating speed to its original state (S24). Next, the main CPU 20 reads a boot image, such as a logotype of the OS, from the flash memory 30, writes the boot image to the main memory 12 (S26), and displays the boot image on the display device via the display controller 16 (S28). Next, the main CPU 22 reads various system modules from the flash memory 30, deploys the various system modules into the main memory 12, and activates the various system modules (S30).

When state information of the information processing device 10 or the like has been saved from the main memory 12 to the flash memory 30 at the time of the previous transition to the standby state, the main CPU 20 reads the saved data from the flash memory 30 and restores the data to the main memory 12. When the initialization of the system module is completed, the main CPU 20 displays a login screen on the system via the display controller 16 (S32). When the user inputs information to the login screen, the main CPU 20 performs a login process by transmitting login information to the server 50 via the network controller 42 or the network 52 (S34).

When the dynamic content intended for the logged-in user is present in the server 50, the main CPU 20 downloads the data of the content via the network 52 and the network controller 42, and writes the data of the content to the main memory 12 (S36). Then, the main CPU 20 creates an initial menu screen using the data written into the main memory 12, or the like (S38), and displays the initial menu screen on the display device via the display controller 16 (S40). Accordingly, the boot process is completed, so that the user can perform a desired operation, such as checking the dynamic content.

Generally, the boot process as illustrated in FIG. 3 requires a time equal to or more than a few seconds. Until the initialization of the system module is completed in S30, an image that can be displayed is limited to static content such as a logotype that has been originally stored in the flash memory 30. In the illustrated processing procedure, after the system module is activated, login to the server 50 is performed, and then the dynamic content downloading is executed. Therefore, the content is displayed after the download, and the static content continues to be displayed during the display.

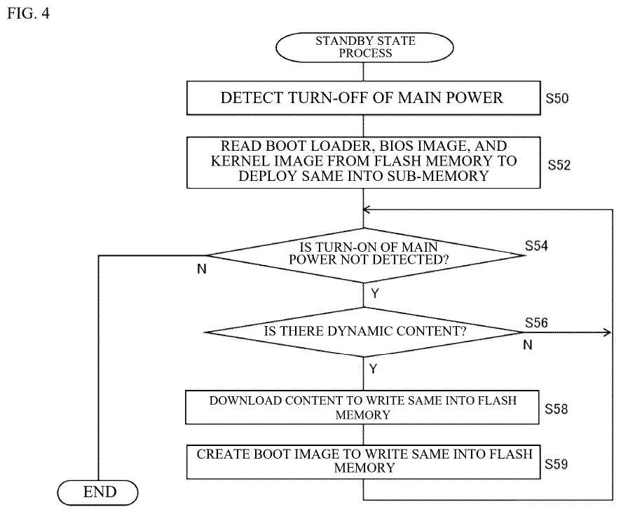

FIG. 4 is a flowchart illustrating a procedure example of a process performed by the information processing device 10 of the present embodiment in the standby state. First, when the user turns off the main power, the system controller 44 detects the turn-off of the main power, and the sub-CPU 38 starts an operation (S50). In this case, as described above, the power supply to the LSI including the main CPU 20 is cut off, and the entire information processing device 10 is in a power saving mode.

First, the sub-CPU 38 reads the boot loader, the BIOS image, and the kernel image from the flash memories 24 and 30 to deploy the same in the sub-memory 34 (S52). As a result, when the information processing device 10 is activated, the main CPU does not need to access the flash memories 24 and 30 to read the data. In addition, the sub-CPU 38 reads information necessary for communication with the server 50, such as the session information stored in the flash memory 30 by the main CPU 20, stores the information in the sub-memory 34, and periodically accesses the server 50 using the information. As a result, the sub-CPU 38 repeatedly confirms whether or not the dynamic content intended for the user is present in the server 50 (Y in S54, and S56).

When the dynamic content is detected (Y in S56), the sub-CPU 38 downloads the data of the content via the network 52 and the network controller 42, and writes the data of the content into the flash memory 30 (S58). Further, the sub-CPU 38 generates a boot image that indicates the presence of the dynamic content or the dynamic content itself to write the boot image into the flash memory 30 (S59). In this case, the GPU 22 does not operate, but is in the standby state, so that there are fewer time constraints and the sub-CPU 38 can generate the boot image by taking its own time.

The boot image may be generated by the sub-CPU 38 itself, or may be data that is generated by the server 50 or the like and downloaded. In this case, the process of S59 can be omitted. When the dynamic content is not present in the server 50 in S56 (N in S56), or after the dynamic content has been downloaded and the boot image has been generated as appropriate (Y in S56, S58, and S59), the sub-CPU 38 appropriately repeats the processes of S56, S58, and S59 during a period in which the system controller 44 does not detect that the main power has been turned on (Y in S54).

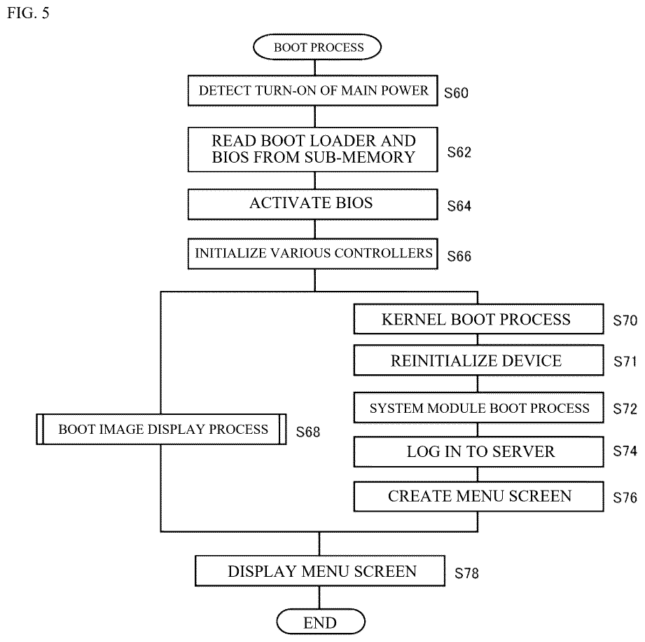

When the system controller 44 detects that the user has turned on the main power, the information processing device 10 ends a standby state process (N in S54). A timing for ending the standby state process is not limited to that illustrated in FIG. 4. For example, even during the process step such as S58 or S59, the information processing device 10 may interrupt the illustrated process at any timing when the main power is turned on, and the process proceeds to the boot process illustrated in FIG. 5.

In S58, the data downloaded from the server 50 may include sensitive data such as personal information of the user. In this case, the sub-CPU 38 stores data, such as a boot image obtained by reconstructing the downloaded image, in the flash memory 30 after performing signature encryption as necessary. Therefore, the transfer of data with the main CUP 20 via the flash memory 30 is safely performed.

FIG. 5 is a flowchart illustrating a procedure example of the boot process of the information processing device 10 according to the present embodiment. First, when the user turns on the main power, the system controller 44 detects the turn-on of the main power, and power is supplied to the LSI including the main CPU 20 (S60). Next, the main CPU 20 reads the boot loader and BIOS image deployed into the sub-memory 34 in S52 of FIG. 4 (S62), and activates the BIOS (S64). Accordingly, the activation can be performed at a high speed without accessing the external flash memory 24.

When the BIOS is activated, the main CPU 20 initializes the IO controllers 40a and 40b, the display controller 16, the memory controller 14, and the flash controller 32 (S66). Then, the main CPU 20 deploys the generated and downloaded boot image from the flash memory 30 into the main memory 12, and then displays the boot image on the display device via the display controller 16 (S68). By using the address conversion mechanism described above, the sub-CPU 38 stores the data of the boot image in the flash memory 30, so that the main CPU 20 can treat the data in the same way as the BIOS boot image, and can display an image related to the dynamic content without waiting for the OS to be activated.

In parallel with the display process of the boot image, the main CPU 22 reads the kernel image deployed into the sub-memory 34 in S52 of FIG. 4, and activates the kernel to shift control to the OS (S70). Then, the main CPU 20 reinitializes the device using the kernel (S71). Next, the main CPU 22 reads the system module, which is part of the kernel, from the sub-memory 34 and activates the system module (S72).

Even in the present embodiment, when the state information of the information processing device 10 or the like has been saved in the flash memory 30 at the time of the previous transition to the standby state, the main CPU 20 may read the saved data from the flash memory 30 and restore the data to the main memory 12. In addition, the main CPU 20 uses the session information stored in the sub-memory 34 or the like to perform a login process for the server 50 via the network controller 42 or the network 52 (S74). Then, the main CPU 20 creates an initial menu screen using the data written into the main memory 12 or the like (S76).

Next, the main CPU 20 ends the boot image display process of S68 and starts displaying the menu screen (S78). Accordingly, the boot process is completed, so that the user can perform a desired operation. According to the illustrated processing procedure, a boot image related to the dynamic content can be displayed during a period in which the BIOS boot image and the OS boot image are displayed in the general boot process illustrated in FIG. 3. Accordingly, the user can confirm and enjoy a variety of content even during the activation. Therefore, when the menu screen is displayed in S78, at least a part of the dynamic content has already been confirmed, which can improve the efficiency of subsequent work.

The boot image may be an advertisement video targeted to the user of the information processing device 10. As described above, since it takes several to several tens of seconds from the time when the BIOS is activated until the entire boot process of the information processing device 10 is completed, and during the time, the advertisement video can be displayed for a short period of time. Since the time when the boot image can be displayed varies depending on the information processing device 10, the server 50 or the sub-CPU 38 selects the advertisement video with an optimal playback time for the information processing device 10 and then provides the advertisement video serving as a download target.

For example, the sub-CPU 38 selects and downloads one advertisement video with a playback time, which is closest to a time when the boot image can be displayed, during the time required for the boot process. Alternatively, the sub-CPU 38 may select and download a plurality of advertisement videos in which the total playback time falls within the time when the boot image can be displayed. By displaying advertisement videos in fields that interest the user at the time of the boot process, the stress felt by the user during the waiting time can be reduced. In addition, it is possible to attract more attention, thereby enhancing the advertising effectiveness. However, the content selected according to the time when the display image can be displayed is not limited to the advertisement video, and may be a moving image shared by another user.

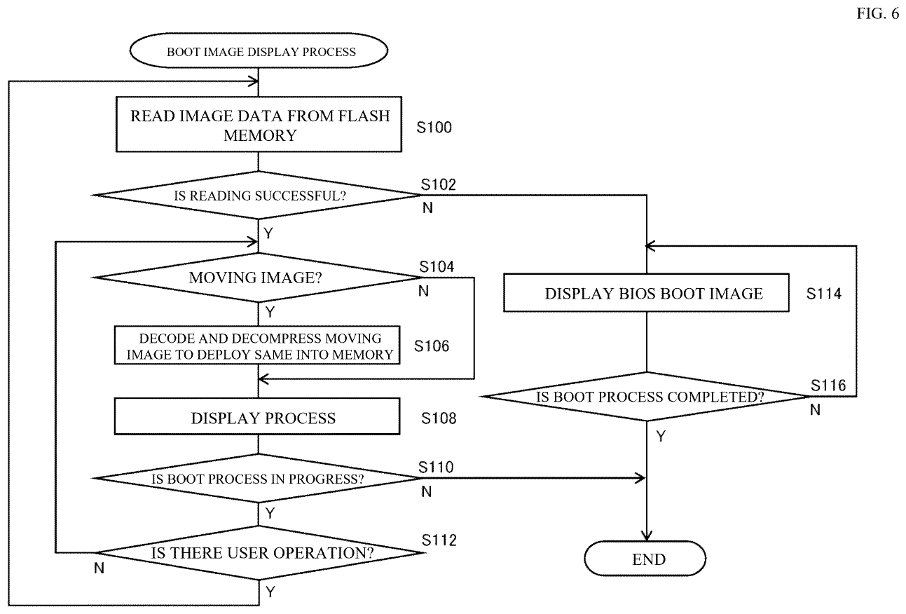

FIG. 6 is a flowchart illustrating a procedure example of a process of displaying the boot image by the main CPU 20 in S68 of FIG. 5. First, the main CPU 20 reads data of the boot image from the flash memory 30 (S100). As described above, the data is downloaded from the server 50 by the sub-CPU 38 or is generated by the sub-CPU 38 itself by reconstructing the downloaded image, in the standby state of the information processing device 10.

When the reading is successful (Y in S102), the main CPU 20 decodes and decompresses the data if the data is moving image data to deploy the data in the main memory 12 (Y in S104, and S106). If the read data is a still image (N in S104), the process of S106 is skipped. In either case, the main CPU 20 writes the read boot image data into the frame buffer of the main memory 12, and displays the boot image data on the display device via the display controller 16 (S108).

Before the boot process up to the creation of the menu screen is completed (Y in S110) illustrated in S76 of FIG. 5, the main CPU 20 continues to display the boot image. In this case, the main CPU 20 accepts a user operation to display another boot image, such as page forwarding. For example, the initial state of the boot image indicates that the dynamic content is being downloaded, such as “You have a message from your friend Tanaka”, and when the user points to the image, it is considered that an image showing the specific content is displayed.

Alternatively, when a plurality of types of dynamic content are acquired, the display may transition to an image of the next content by the user pointing to the image of one of the displayed content. When such a user operation has been performed (Y in S112), the main CPU 20 reads data of another boot image determined by the user operation from the flash memory 30 (S100), and repeats the process from S102 to S108. If there is no user operation (N in S112), the main CPU 20 continues to decode and decompress the moving image being displayed as necessary, and continues to display the same (S104 to S108).

When data of the boot image to be displayed is not present in the flash memory 30 or when undisplayed boot image has been depleted, if the data reading in S100 is unsuccessful (N in S102), the main CPU 20 reads the boot image data of the BIOS (or OS) from the flash memory 30 to display the boot image data (S114). Even in this case, the main CPU 20 continues to display the boot image such as the BIOS until the boot process up to the creation of the menu screen illustrated in S76 of FIG. 5 is completed (N in S116, and S114).

When the boot process is completed, the main CPU 20 ends the display of the boot image displayed in S108 or the boot image of the BIOS displayed in S114 (N in S110 and Y in S116). As a result, as illustrated in S78 of FIG. 5, the display is switched from the boot image to the menu screen.

The aspects illustrated in FIGS. 4 to 6 allow the main CPU 20 to immediately display the boot image that has been downloaded or generated by the sub-CPU 38 after the BIOS is activated, thereby effectively use the waiting time of the user. On the other hand, the data supplied from the sub-CPU 38 to the main CPU 20 using the address conversion mechanism illustrated in FIG. 2 is not limited to the images. For example, even when the main CPU 20 uses patch files for applications downloaded by the sub-CPU 38 or data for additionally provided content, the present invention sufficiently exhibits the effect.

In the general information processing device, the system controller 44 activates the main CPU 20 when the download from the server 50 is necessary in the standby state. In response to the activation, the main CPU 20 activates the kernel to access the server 50, and executes the download. When the download is completed, the sub-CPU 38 is activated and the main CPU 20 transitions to the standby state. According to the present embodiment, the sub-CPU 38 completes the download without undergoing the complicated procedures. In addition, when the information processing device 10 is activated, the main CPU 20 can read the downloaded data from the flash memory 30 immediately after the BIOS is activated, and can perform a possible process or prepare for a subsequent possible process.

When the user turns on the main power of the information processing device 10 while the sub-CPU 38 downloads the data, the sub-CPU 38 may store various information necessary for restarting the download in the flash memory 30 together with the data that is being downloaded. The information necessary for restarting the download is, for example, at least one of an IP address of the server, a session number specified by a communication protocol such as a transmission control protocol (TCP), a sequence number, and a session key obtained by authentication with the server. Accordingly, it is possible for the main CPU 20 to restart the download from a point at which the download is interrupted by the sub-CPU 38 in the middle, after the kernel is activated.

According to the present embodiment described above, the flash controller provides a logical address space for implementing access to the flash memory for each of the main CPU and the sub-CPU. In this case, the logical address space for the main CPU includes an area of a logical address that can only be used by the main CPU, and an area of a logical address that can be used by the sub-CPU. By providing the common address space for both the sub-CPU and the main CPU in this way, the sub-CPU can share the limited storage area of the flash memory with the main CPU without having the same file system as the main CPU.

By using such a logical address space, when the information processing device is in the standby state, the sub-CPU stores the dynamic content downloaded from the server in the flash memory. Accordingly, when the information processing device is activated, the main CPU can read the data before activating the OS, and perform the possible process. As a result, the process that needs to be performed after the main CPU has completed the boot process is accumulated, so that it is possible to reduce the length of waiting time of the user or the restriction of the processing speed.

In addition, the main CPU can display images showing application update information, user notifications, still images or videos shared by other users, advertisements, and the like downloaded or generated by the sub-CPU in parallel with the OS boot process. Accordingly, the user who has activated the information processing device to enjoy images and recognize necessary information while utilizing the time until the user can actually use the information processing device. Moreover, by displaying the advertisement during such a waiting time, it is possible to attract attention and enhance the advertising effectiveness.

The present invention has been described above based on the embodiment. The above-described embodiment is merely an example, and it will be understood by those skilled in the art that various modifications are possible as combinations of components and processes, and that such modifications are also within the scope of the present invention.

### INDUSTRIAL APPLICABILITY

As described above, the present invention can be used in memory controllers or information processing devices such as personal computers and game devices that are installed in the memory controllers.

### REFERENCE SIGNS LIST

10 Information processing device, 12 Main memory, 20 Main CPU, 30 Flash memory, 32 Flash controller, 34 Sub-memory, 36 Memory controller, 38 Sub-CPU, 42 Network controller, 44 System controller, 50 Server, 52 Network, 54 Input device

1. A memory controller for acquiring an access request to a secondary storage device from a main CPU and a sub-CPU that are provided in an information processing device and for executing a corresponding access process, wherein the memory controller performs operations comprising:
generating a logical address space for the sub-CPU,
mapping the logical address space for the sub-CPU to a logical address space for the main CPU, and
executing the access process to the secondary storage device based on the logical address specified in each logical address space in response to the access request.

2. An information processing device comprising:
a sub-CPU;
a main CPU that is configured to cause an image that was stored in a secondary storage device by the sub-CPU when the main CPU was in a standby state to be displayed on a display device as a boot image during a boot process of the information processing device; and
a memory controller for acquiring an access request to the secondary storage device from the main CPU and the sub-CPU and for executing a corresponding access process, wherein the memory controller performs operations comprising:
generating a logical address space for the sub-CPU,
mapping the logical address space for the sub-CPU to a logical address space for the main CPU, and
executing the access process to the secondary storage device based on the logical address specified in each logical address space in response to the access request.

3. The information processing device according to claim 2, wherein, when the main CPU is in the standby state, the sub-CPU performs operations comprising:
reading session information stored in the secondary storage device by the main CPU,
using the session information to access a server,
downloading data, and
storing the data in the secondary storage device.

4. The information processing device according to claim 3, wherein, when the main CPU is in the standby state, the sub-CPU performs operations comprising:
generating image data to be displayed on the display device by the main CPU based on the data downloaded from the server, and
storing the image data in the secondary storage device.

5. The information processing device according to claim 2, wherein the main CPU is configured to shift the display to another boot image in response to a user operation, while the boot image is displayed.

6. The information processing device according to claim 2, wherein the main CPU is configured to display an advertisement video downloaded by the sub-CPU as the boot image.

7. The information processing device according to claim 6, wherein the sub-CPU is configured to select and download the advertisement video having a corresponding playback time based on a time to display the boot image.

8. The information processing device according to claim 3, wherein
the sub-CPU is configured to:
store information necessary for restarting the download in the secondary storage device when the main CPI is activated during data download, and
transition to the standby state, and
the main CPU is configured to restart the download using the information necessary for restarting the download that is read from the secondary storage device.

9. The information processing device according to claim 2, wherein the sub-CPU is configured to store, in a primary storage device, program data for the boot process of the information processing device that is stored in the secondary storage device, when the main CPU is in the standby state, and
the main CPU is configured to execute the boot process using the program data stored in the primary storage device.

10. A method for processing access to a secondary storage device, comprising:
generating a logical address space for a sub-CPU, in which the logical address space is a space of logical addresses for allowing a main CPU and the sub-CPU to implement the access to the secondary storage device, and mapping the logical address space for the sub-CPU to a logical address space for the main CPU;
acquiring, from the main CPU and the sub-CPU, an access request to a common storage area, which specifies a logical address in each logical address space; and
executing an access process to the secondary storage device based on the specified logical address in response to the access request.

11. The method of claim 10, comprising:
reading, by the sub-CPU when the main CPU is in the standby state session information stored in the secondary storage device by the main CPU,
using the session information to access a server,
downloading data, and
storing the data in the secondary storage device.

12. The method of claim 11, comprising:
generating, by the sub-CPU when the main CPU is in the standby state, image data to be displayed on the display device by the main CPU based on the data downloaded from the server, and
storing the image data in the secondary storage device.

13. The method of claim 11, comprising shifting, by the main CPU, the display to another boot image in response to a user operation, while the boot image is displayed.

14. The method of claim 11, comprising displaying, by the main CPU, an advertisement video downloaded by the sub-CPU as the boot image.

15. The method of claim 14, comprising, selecting and downloading, by the sub-CPU, the advertisement video having a corresponding playback time based on a time to display the boot image.

16. The method of claim 12, comprising:
storing, by the sub-CPU, information necessary for restarting the download in the secondary storage device when the main CPI is activated during data download,
transitioning, by the sub-CPU, to the standby state, and
restarting, by the main CPU, the download using the information necessary for restarting the download that is read from the secondary storage device.

17. The method of claim 16, comprising:
storing, by the sub-CPU, in a primary storage device, program data for the boot process of the information processing device that is stored in the secondary storage device, when the main CPU is in the standby state, and
executing, by the main CPU, boot process using the program data stored in the primary storage device.

18. One or more non-transitory computer-readable media that store instructions which, when executed by one or more computer processors, cause the one or more computer processors to perform operations for processing access to a secondary storage device, the operations comprising:
generating a logical address space for a sub-CPU, in which the logical address space is a space of logical addresses for allowing a main CPU and the sub-CPU to implement the access to the secondary storage device, and mapping the logical address space for the sub-CPU to a logical address space for the main CPU;
acquiring, from the main CPU and the sub-CPU, an access request to a common storage area, which specifies a logical address in each logical address space; and
executing an access process to the secondary storage device based on the specified logical address in response to the access request.

19. The media of claim 18, wherein the operations comprise:
reading, by the sub-CPU when the main CPU is in the standby state session information stored in the secondary storage device by the main CPU,
using the session information to access a server,
downloading data, and
storing the data in the secondary storage device.

20. The media of claim 19, wherein the operations comprise:
generating, by the sub-CPU when the main CPU is in the standby state, image data to be displayed on the display device by the main CPU based on the data downloaded from the server, and
storing the image data in the secondary storage device.

21. The media of claim 19, wherein the operations comprise shifting, by the main CPU, the display to another boot image in response to a user operation, while the boot image is displayed.
